(19) United States
(12) Patent Application Publication
(10) Pub. No.: US 2008/0059994 A1
(43) Pub. Date: Mar. 6, 2008

(54) Method for Measuring and Selecting Advertisements Based Preferences

(76) Inventors: Jay E. Thornton, Watertown, MA (US); Paul H. Dietz, Hopkinton, MA (US); Kent B. Wittenburg, Lynnfield, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/760,845

(22) Filed: Jun. 11, 2007

Related U.S. Application Data
(63) Continuation-in-part of application No. 11/445,788, filed on Jun. 2, 2006.

(51) Int. Cl. H04N 7/10

(52) U.S. Cl. 725/32

(57) ABSTRACT

A method determines an amount of time consumers are viewing an advertising display. A sequence of images is acquired by a camera of a scene in front of an advertising display. Faces are detected in the sequence of images. For each detected face, determine an orientation of the face with respect to the advertising display and a preference for a particular advertisement can be determined.

### RELATED APPLICATIONS

This application is a Continuation in Part of U.S. patent application Ser. No. 11/445,788, “Method for Metered Advertising Based on Face Time” filed by Dietz et al. on Jun. 2, 2006.

### FIELD OF THE INVENTION

This invention relates generally to advertising systems, and more particularly to a method for measuring and selecting advertisements based on consumer preferences.

### BACKGROUND OF THE INVENTION

In most cases, the price of advertising is closely linked to the number of people that experience the advertisement. For example, newspaper and magazine advertisers pay according to circulation, and web advertisers typically pay a per viewer fee. That technology easily supports metered advertising.

For television advertising, the situation is somewhat different. In general, a broadcaster does not know in advance precisely how many viewers will see a particular advertisement. So extensive efforts are made to predict the probable number of viewers, and pricing is set accordingly. It is not unusual to guarantee a minimum audience size, and if this is not achieved, the advertisement is rerun until the requisite number is reached. The number of viewers is typically determined by an independent auditing firm that uses statistical sampling techniques. For example, the Nielsen Television Ratings is the single most important element in determining advertising rates on a world wide base. Unfortunately, those techniques at best provide an estimate of the audience size, the actual size is never known.

For large public advertising displays, the situation is even more poorly defined. While advertising rates for advertising display are typically driven by estimates of traffic in an area, be it pedestrian or automotive, the large number of signs makes it impractical perform a detailed statistical studies on the number of viewers for each particular sign. Thus, advertisers have been forced to accept a pricing model that very poorly estimates the number of viewers, and their preferences. This problem is even more difficult when the advertising display is changing or varying over time, and the audience is constantly changing.

Another issue is determining appropriate advertising. Conventionally, an advertising company might use a panel or focus group to quantify the “typical” reaction to a particular ad. To obtain actual “field data”, advertisers often have very delayed and very diffuse feedback on their content. It takes a long time to get new sales numbers and it is not clear which ads in the campaign are the good ones.

### SUMMARY OF THE INVENTION

The embodiments of the present invention provide a business system and method for determining advertising preferences based on an amount of time viewers face particular advertising displays. The presumption is that when their feces are oriented towards the advertisements it is to view them.

In a preferred embodiment, the advertising displays uses display screens or billboards that can display different advertisements at the same time.

The method uses computer vision techniques to count the number of faces in an image that are viewing different advertising displays. The system can include one or more cameras arranged to view a scene in front of the adverting displays. By summing the time each face appears in images acquired by the camera, i.e., the ‘face time’, the method can keep track of the ‘total preference,’ i.e., the total amount of time the different advertisements were looked at. This allows advertisers to select appropriate advertisements based on consumers viewing them. If alternative advertisements are displayed side by side, preferences for one or the other advertisement can be determined, and the selected advertisement can be later used.

### BRIEF DESCRIPTION OF THE DRAWINGS

FIG. 1 is a schematic of a system for measuring advertisement preference according to an embodiment of the invention; and

FIG. 2 is a flow diagram of a method for metering advertisements according to an embodiment of the invention.

### DETAILED DESCRIPTION OF THE PREFERRED EMBODIMENT

Advertisement Selection System

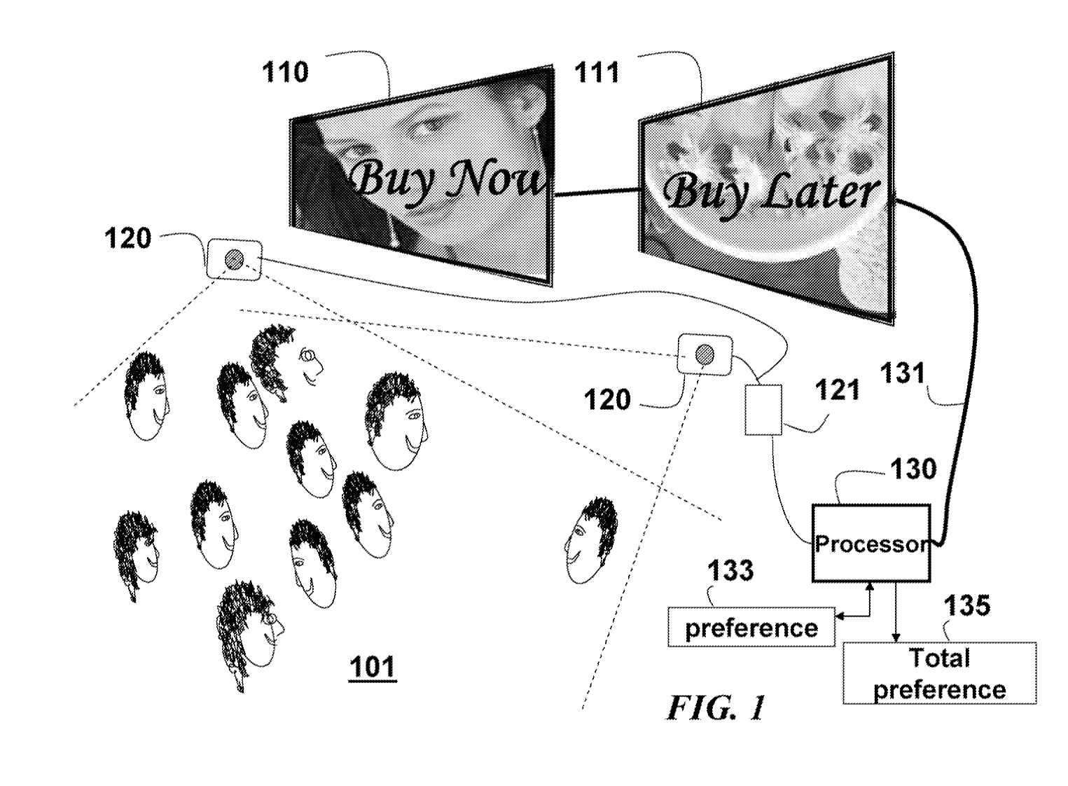

FIG. 1 shows a system for metering ‘preference’ 133 and ‘total preference’ 135 for different advertisements according to an embodiment of our invention. The system includes advertising displays 110-111, a set of cameras 120, and a processor 130. The set of cameras can include one or more cameras.

In a preferred embodiment, advertising displays 110-111 can change over time. For example, the display is a billboard with vertically rotating members as known in the art, see U.S. Pat. No. 5,572,816, “Rotating advertising sign with rotating louvers,” issued to Anderson on Nov. 12, 1996, incorporated herein by reference. Alternatively, the display uses one or more television screens, or rear projection, or a large scale liquid crystal display (LCD) screen as are now common in public areas;

In any case, the processor 130 can determine, via a connection 131, which of the several advertisements are is being displayed at any time, and for how long. It is possible that the advertising schedule is downloaded to the processor ahead of time, or after the fact when preference is being determined, as described herein.

It is also possible that the advertising displays 110-111 are dynamically updated by the processor 130 depending on demographics of consumers in the scene, as described in greater detail below.

The set of cameras 120 is arranged to view a scene 101, for example, a sidewalk: outside a store, spectators in a stadium, or an arcade inside a shopping mall. Each camera acquires periodically images 121 of the scene. For example, each camera is a video camera and acquires images at a rate of thirty frames per second. Other frame rates can also be used. It should also be noted that the cameras can be a pan-tilt-zoom camera to acquire more detailed images of the scene 101. Better localization of persons in the scene can be performed if more than one camera 120 is used.

Advertisement Selection Method

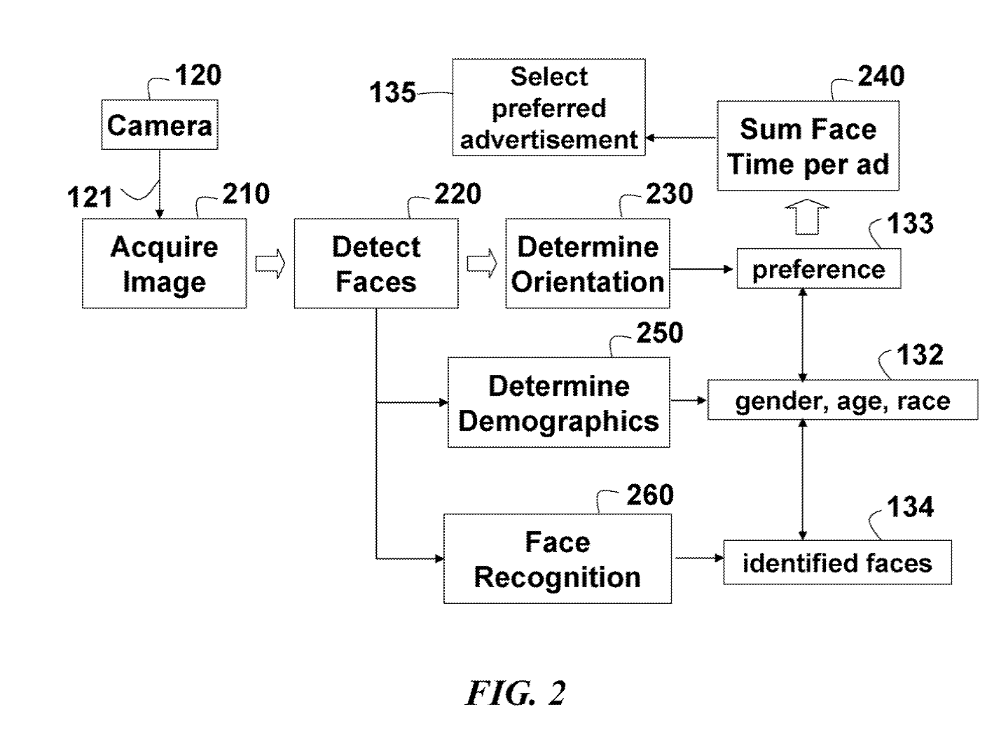

As shown in FIG. 2, the images 121 are acquired 210 from each camera 120. Computer vision techniques are applied to the images. Specifically, face detection 220 is used to locate face, see U.S. Pat. No. 7,020,337, “System and Method for Detecting Objects in Images,” issued to Viola et al, on Mar. 28, 2006, incorporated herein by reference. After the faces are located, orientations of the faces can be determined 230 with respect to the advertising display 110, using conventional methods. If necessary, pedestrian recognition techniques can be used to first detect and localize consumers, and then to focus on one or more particular faces, see U.S. patent application Ser. No. 10/463,800, “Detecting Pedestrians Using Patterns of Motion and Appearance in Videos,” filed by Viola et al. on Jun. 17, 2003, incorporated herein by reference.

By tracking the faces in a sequence of images, it is possible to measure and sum 240 the preference 133 for a particular advertisement to obtain the total preference 135 per advertisement. The preference can be determined by counting the number of frames in which each face appeared. This enables the selection of appropriate advertisements for mass marketing or targeted marketing. It is also possible to threshold the time for each face so that only casual glances at the display are not considered,

It should be noted, that other known face-based computer vision techniques can also be applied to determine demographics 250 of the faces, such as gender, age, and race. The demographics can be correlated 132 with the preference 133.

It is also possible to perform face recognition 260 to perform long term tracking of identified faces 134, see U.S. Pat. No. 7,031,499, “Object Recognition System,” issued to Viola et al. on Apr. 18, 2006, incorporated herein by reference. It should be noted, that all of these computer vision techniques can use the same so robust: ‘Viola-Jones’ rectangular filtering procedure, greatly simplifying the processing.

Metering preference and demographics enables new business methods. These include the following.

An advertisement is displayed for a predetermined amount of time, but the fee depends upon the actual preference for the advertisement.

The advertiser pays for a predetermined amount of face time, and the advertisement is displayed until this amount is reached. It should be noted that an advertisement can be displayed intermittently with other advertisements. The advertising schedule can then correlate face times with particular advertisements.

An advertiser is guaranteed a predetermined amount of face time for a certain time interval. If the face time is not met, an accommodation is made, such as running the advertisement longer, or rebating part of the fee.

Advertisers may desire an independent verification of the face time data. An auditing service can provide the equipment, and determines face time statistics. The statistics can be provided in real-time to help determine specific advertisements to display.

As described above, computer vision techniques can be used extract demographic information in real-time from the images. This enables advertising pricing to be determined by preferences for particular demographic groups.

In addition to demographic information, the system can also recognize other object features of interest to advertisers. For example, a laser eye surgery service may wish to target consumers wearing glasses, and the system could be configured to track preferences time of just this group of consumers.

For changeable displays, the display typically switches among different advertisers. If the pricing is based on preference of particular groups, then it is desirable to change advertisement are being shown and for how long dependent upon demographics of current viewers so as to maximize the value of the displayed advertisements

The embodiments can be combined with other known processes. For example, preference pricing can be weighted by the number of unique consumers. These variations are within the scope of the current invention.

It is also possible to place one or more cameras at various locations. Despite different viewpoint, it is still possible to determine which faces are oriented towards the advertising display 110;

Selecting Advertisements

While total preference is a good meter of cumulative advertising exposure, it is not sensitive to advertising preference because the same total time might be obtained from a good advertisement in a low traffic area, and a poor advertisement in a high traffic area. To quantity preference for an advertisement, it is important to remove all extraneous factors, e.g. time of day, location, and effecting viewing time.

A good way to control extraneous factors is to display several advertisements side by side, e.g., advertisement A and B on a left/right rotating basis, and classify frontal faces accordingly. This method is called “two alternative forced choice” (2AFC) in psychological research. The 2AFC is regarded as one of the most sensitive and objective methods available, see G. S. Brindley, 1970, Physiology of the Retina and Visual Pathway, Williams and Wilkins, Baltimore, Md.

To automatically perform 2AFC for each face gazing in the direction of the displays, two cameras (one over advertisement A and one over advertisement B), locate frontal facing faces. A person is classified as preferring advertisement A or B based on which one they face the longest time.

Alternatively, it is possible to use a single camera and determine which advertisement the person is looking at. For each person a measure, of their preference for advertisement can be derived from a proportion of time the person is looking at each advertisement. Thus, we can measure preference for individuals, as well as a group of people, integrated over time. The preferred advertisement data can be correlated with other demographic data to ultimately pick the ‘better’ advertisement for a particular location/time/demographic.

As an advantage, the selection process can be performed on a small scale, before a particularly selected advertisement is deployed on a large scale.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim;

1. A method for selecting advertisements, comprising:
displaying concurrently a plurality of advertisements on an advertising display;
acquiring a sequence of images of a scene in front of the advertising display with a camera;
detecting faces in the sequence of images;
determining, for each detected face, an orientation of the face with respect to the advertisements;
measuring, for each face, an amount of time each face is oriented towards each advertisement display;
summing the times for each of the faces to determine a total preference for each advertisement; and
selecting the advertisements based on the total preference for each advertisement;

2. The method of claim 1 further comprising;
displaying different advertisement on the advertising display over time; and
determining the total preference for each advertisement;

3. The method of claim 1, further comprising:
determining, for each face, demographics; and
associating the demographics with the total preference.

4. The method of claim 3, further comprising:
displaying different advertisements on the advertising display according to the demographics and the preferences.

5. The method of claim 1, in which detailed images of the faces located in the sequence of images are acquired:

6. The method of claim 1, further comprising:
recognizing the faces in the sequences of frames to correlate specific faces to the total preference.

7. The method of claim 1, further comprising:
determining, for each face, demographics; and
correlating the total preference for each displayed advertisements according the demographics of the face.

8. The method of claim 1, further comprising:
determining a proportion of time each advertisement is viewed.

9. The method of claim 1, in which the summing only includes times of each face that are larger than a threshold.

10. A method for selecting advertisements, comprising:
displaying concurrently a plurality of advertisements on an advertising display;
acquiring a sequence of images of a scene in front of the advertising display with a camera;
detecting faces in the sequence of images;
determining, for each detected face, an orientation of the face with respect to the advertisements;
measuring, for each face, a proportion of time each face is oriented towards each advertisement display;
summing the proportions over all of the feces to determine a total preference for each advertisement; and
selecting the advertisements based on the total preference for each advertisement.

11. A system for determining an amount of time consumers are viewing an advertising display, comprising:
an advertising display;
a camera configured to acquire a sequence of images of a scene in front of the advertising display;
a face detector configured detect faces in the sequence of images and an orientation of each detected face with respect to the advertising display;
means for measuring, for each face, a proportion of time each face is oriented towards each advertisement display;
means for summing the proportions over all of the faces to determine a total preference for each advertisement; and
selecting the advertisements based on the total preference for each advertisement.
